(19) United States
(12) Patent Application Publication
(10) Pub. No.: US 2006/0062593 A1
(43) Pub. Date: Mar. 23, 2006

(54) Apparatus and method for image forming

(76) Inventor: Mitsuru Takahashi, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/227,144

(22) Filed: Sep. 16, 2005

(30) Foreign Application Priority Data
Sep. 17, 2004 (JP) 2004-271479

(51) Int. Cl. G03G 21/16

(52) U.S. Cl. 399/121

(57) ABSTRACT

An image forming apparatus includes housing, an intermediate transferring body, a transferring member, a cover member, and a transferring member moving mechanism. The intermediate transferring body is removable from the housing along the rotation axis of the intermediate transferring body. A transferring member transfers the image from the intermediate transferring body to a transferring material. A cover member supports the transferring member and opens and closes in the direction that is perpendicular to the rotation axis of the intermediate transferring body. A transferring member moving mechanism moves the transferring member between a first position that the transferring member contacts with the intermediate transferring body and a second position that the transferring member removes from the intermediate transferring body.

### CROSS-REFERENCE TO RELATED APPLICATION

This document claims priority to, and contains subject matter related to, Japanese Patent Applications No. 2004-271479, filed on Sep. 17, 2004, which is incorporated herein by reference.

### BACKGROUND OF THE INVENTION

1. Field of the Invention

The present invention relates to an image forming apparatus such as a copier, a laser beam printer, an LED printer and a facsimile using a belt unit. The present invention relates to an image forming apparatus including an intermediate belt unit that can be attached to and detached from a main body of the image forming apparatus.

2. Discussion of the Background

The use of various transfer components, including a transfer bet, to transfer an image in an image forming apparatus using an electrophotographic method, is well-known. Because such components are expendable supplies, transfer belts and related components are preferably accessible and/or removable from an image forming apparatus. Also, as known to all users of image forming devices, paper jams are possible, thus requiring improved paper flow designs and easy access to paper flow paths.

Japanese Patent Laid-Open No. 11-73035 describes an image forming apparatus that includes an intermediate transfer belt unit, which is removable from the apparatus along a rotational axis of the intermediate transfer belt. However, additional transfer elements are not easily accessed via an access plate and are not easily removable for component repair/replacement and paper jam clearing.

Japanese Patent Laid-Open No. 11-352741 describes an image forming apparatus that includes a first side plate, a second side plate, an image support body, a developing device and an intermediate transfer component. The image support body, the developing device and the intermediate transfer component are disposed between the first side plate and the second side plate and removable respectively. The image support body and the developing device are removable in a direction perpendicular to the side plates. The intermediate transfer component is removable in a direction perpendicular from a rotational axis of the intermediate transfer belt. However, the intermediate transfer component is not removable along a rotational axis of the intermediate transfer component. Also, additional transfer elements are not easily accessed via an access plate and are not easily removable for component repair/replacement and paper jam clearing.

Japanese Patent Laid-Open No. 2000-231321 describes an image forming apparatus that includes a transfer roller within an access component. However, this reference does not include an intermediate transfer device of any sort. Thus, this device also does not include a transfer device movement mechanism configured to move the transfer roller in and out of contact with an intermediate transfer device. Also, additional transfer elements are not easily accessed via an access plate and are not easily removable for component repair/replacement and paper jam clearing. Furthermore, this apparatus is not configured for color operations.

Thus, as discovered by the present inventors, what is desired is a construction that allows for easier access and removal of intermediate and other transfer devices.

### SUMMARY OF THE INVENTION

It is a general object of the present invention to provide a belt unit in which one or more of the above-mentioned problems are eliminated.

A first object of the present invention is to provide an improved image forming apparatus including an intermediate transfer body unit which can be easily attached and detached from the image forming apparatus without abutting a surface of an image support body.

A second object of the present invention is to provide an improved image forming apparatus which can easily perform jam processing as necessary.

In order to achieve the above-mentioned objects, there is provided, according to one aspect of the present invention, an image forming apparatus including a housing, an image support body, a developing member, an intermediate transferring body, a transferring member, a cover member, and a transferring member moving mechanism. The intermediate transferring body is removable from inside of the housing to outside along the rotation axis of the intermediate transferring body. A transferring member transfers the image from the intermediate transferring body to a transferring material. A cover member supports the transferring member and opens and closes in the direction that is perpendicular to the rotation axis of the intermediate transferring body. A transferring member moving mechanism moves the transferring member between a first position where the transferring member contacts with the intermediate transferring body, and a second position where the transferring member is not in contact with the intermediate transferring body.

A third object of the present invention is to provide a novel method of attaching a transferring body to a housing of an image forming apparatus in a detachable manner.

In order to achieve the above-mentioned third object, there is provided, according to one aspect of the present invention, a method and apparatus for attaching a transferring body to a housing of an image forming apparatus in a detachable manner that includes steps and devices for inserting, positioning, closing, locking. Here, the transferring body is inserted into the apparatus along the rotation axis of the transferring body through an opening of the housing. The transferring body is then positioned in the housing. The opening of the housing is covered by a plate. The transferring body is locked with a first locking mechanism.

Other objects, features and advantages of the present invention will become more apparent from the following detailed description when read in conjunction with the accompanying drawings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows an exemplary structure of an image forming apparatus according to an embodiment of the present invention.

FIG. 2 is a perspective view showing a frame constitution of a main body of the image forming apparatus.

FIG. 3 is a perspective view showing an intermediate transfer body unit when the intermediate transfer body unit is supported by guide-rails.

FIGS. 4A and 4B are schematic views showing a locking mechanism that regulates removing of the intermediate transfer body unit.

FIGS. 4C and 4D are schematic views showing a detecting mechanism that detects locking of the intermediate transfer body unit.

FIGS. 5A and 5B are schematic views showing a locking member 53a that regulates removing of the intermediate transfer body unit.

FIG. 6 is schematic view showing opening of a second transferring cover at the time of jam processing.

FIG. 7 is schematic view showing a state of a second transferring roller at the time of non-image processing.

FIG. 8 is schematic view showing the state of the second transferring roller at the time of image processing.

FIG. 9 is schematic view -showing an attaching and detaching mechanism of the second transferring roller to and from the intermediate transfer body unit.

### DETAILED DESCRIPTION OF THE PREFERRED EMBODIMENTS

The best mode for carrying out the invention is explained below with reference to the figures. The present invention is not limited to the specifically disclosed embodiments, and variations and modifications may be made without departing from the scope of the present invention.

Reference will now be made in detail to the present preferred embodiments of the invention, examples of which are illustrated in the accompanying drawings. Wherever possible, the same reference numbers are used in the drawings and the description to refer to the same or like parts.

A present embodiment is constituted as a full color printer using an intermediate transferring method.

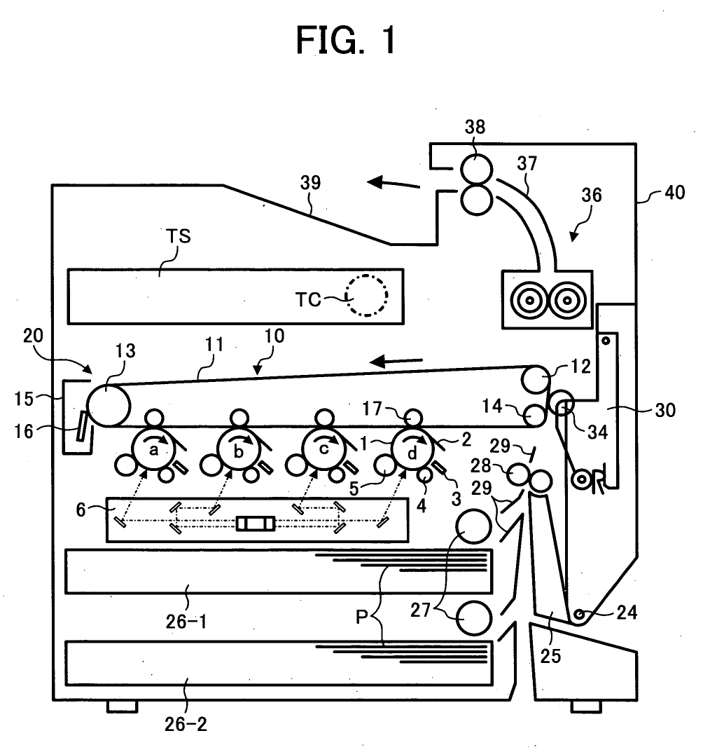

FIG. 1 shows an intermediate transfer belt 11 supported by support rollers 12, 13, 14 is disposed approximately centrally of a main body of an image forming apparatus in the crosswise direction. Four image-forming units are aligned along lower running side of the intermediate transfer belt 11.

Image forming elements, such as a charging device 4 configured to charge the photoconductor 1, a developing device 5 configured to develop a latent image on the photoconductor 1 by each color toner into a toner image, a cleaning device 2 for removing toner particles remaining on the photoconductor 1, are placed around the photoconductor 1 respectively. This image-forming unit preferably can serve as a process cartridge.

Though the components of the image forming units a, b, c and d is similar, the color of toner contained in each developing device 5 is magenta, cyan, yellow, black respectively, is different from each other. An exposing device 6 is disposed in the lower part from the image-forming unit. The exposing device 6 forms a latent image by irradiating a laser beam corresponding to each color image information in a surface of the photoconductor 1. Also, it is possible to adopt an exposing device including LED array and image forming mechanisms.

The intermediate transfer belt 11 includes a resin film or rubber substratum having 50-600 μm in thickness. The intermediate transfer belt 11 has a resistance value that enables a toner to transfer from photoconductor 1. As shown in FIG. 1, the intermediate transfer belt 11 is rotated in counterclockwise by a drive roller 12 coupled with drive mechanisms (not shown). A transfer roller 17, which is a first transferring mechanism, is placed at a backside surface of the intermediate transfer belt 11, which is contact with and opposed to the photoconductor 1. These intermediate transfer belts 11, support rollers 12, 13, 14 and the first transfer roller 17 are possible to be attached and detached to and from the main body of image forming apparatus together as a intermediate transfer device.

A cleaning device 15, having cleaning blade 16 configured to clean the toner and paper powders remaining on the surface of intermediate transfer belt 11, is disposed at a position opposed to the support roller 13 in the outside of the belt loop. The cleaning device 15 with the intermediate transferring device 10 is removal from the main body of the image forming apparatus as an intermediate transferring unit 20. A mechanism and a method of attachment and detachment are described below. In addition, of course, it is possible the cleaning unit 15 can be attached and detached from the intermediate transferring device 10 and the main body of the image forming apparatus.

In the drawings, a second transferring unit 30 is disposed in the right side of the intermediate transfer belt 11. A transfer roller 34, as a re-transfer member (second transferring member), configured to transfer the toner from the intermediate transfer belt 11 to a recording medium is disposed at the vicinity of the drive roller 12 supporting the 10 intermediate transfer belt 11 in the second transferring unit 30. When the image forming is not performed, the transfer roller 34 becomes to slightly separate from the intermediate transfer belt 11 as a normal position. On the contrary, when the image forming is performed, the transfer roller 34 is pressed to contact with the intermediate transfer belt 11 by pressing member. A mechanism of attachment and detachment of the transfer roller to the intermediate 15, transfer belt is described below.

Paper feeding cassettes 26-1, 26-2 including papers P as recording mediums are disposed in a paper supplying device at a lower part of the main body of the image forming apparatus.

A paper in the highest position of the paper feeding cassette is fed by a feeding device 20 including paper rollers 27, and guided by plural guide member 29 and 25, and transported to a resisting roller pair 28.

A fusing device 36 including a source of heat such as a heater is disposed at the upper part above the second transferring unit 30. An outputting guide 37 and an outputting roller 38 are placed behind the fusing device 36.

The second transferring cover 40 configured to support the second transferring unit 30 and to constitute a part of the main body has a structure that is possible to rotate and open around a shaft 24. When a paper jam occurs, the second transferring cover 40 is opened to remove the paper from a path of paper transportation easily.

An outputting stack portion 39 is formed on the top surface of the main body of the image forming apparatus.

A toner cartridge containing portion TS configured to contain four toner cartridges TC including supplying toner is disposed in the lower part of the outputting stack portion 39 and the upper part of the intermediate transfer belt 11. Colors of the toner of the toner cartridges TC are four colors of magenta, cyan, yellow and black, and the toner is supplied to a developing device 5 corresponding to color of the toner by a powder pump device (not shown).

A process for forming an image with the image forming apparatus constructed as above is explained below.

A signal for writing is sent by a host machine such as a computer. The exposing device 6 is driven based on a received image signal. A light from a laser light source (not shown) of the exposing device is scanned by a polygon mirror rotationally driven by a motor, and is irradiated to a photoconductor drum 1 uniformly charged with electricity with the charging device 4, through mirrors, to form a latent image corresponding to a writing information on the photoconductor drum 1.

The latent image formed on the photoconductor drum 1 is developed with the toner of the developing device 5, then, the toner image is formed and held on the surface of the photoconductor drum 1. The toner image is transferred from the photoconductor drum 1 to the surface of the intermediate transfer belt 11, which moves to synchronize with the photoconductor drum 1, by the first transferring roller 17.

After toner image transferring, the toner remaining on the surface of the photoconductor drum 1 is cleaned by the cleaning device 2. After that, the photoconductor drum 1 is neutralized by a charging neutralization device 3, and entered a standby state for next image producing cycle.

The intermediate transfer belt 11 moves to a direction shown in FIG. 1 as an arrow, carrying the toner image transferred from the photoconductor drum 1 in the image forming unit a. Also, a latent image corresponding to another color is formed in a photoconductor drum 1b in an image forming unit b, and is developed with a toner of corresponding color to be a toner image. This toner image is overlaid on the toner image that is formed on the intermediate transfer belt 11 previously. Finally, a full color image is obtained by overlying the four-colored toner images formed by the image forming units a, b, c, d respectively.

When the toner image on the intermediate transfer belt 11 moves to a predetermined place, paper feeding is started. Paper rollers 27 rotate in the direction of the arrow. The paper in the highest position of the paper feeding cassette 26-1 or 26-2 is drawn by the feeding device including paper rollers 27, and the paper is transported to the resisting roller pair 28. The paper is fed from the resisting roller pair 28 so that a four-color overlaid toner image on the intermediate transfer belt 11 is transferred to a side of the paper P sent between the intermediate transfer belt 11 and the secondary transcription roller 34. An operation of the resisting roller pair 28 is controlled and/or timed so that the transfer media (e.g., paper) is presented to a nip position at roller 34 at the appropriate time.

In this embodiment, polarity of an electrostatic latent image formed in the surface of the photoconductor drum 1 is positive, and polarity of the toner formed on the photoconductor 1 is negative. The toner held on the photoconductor 1 is transferred to the intermediate transfer belt 11 by giving an electric charge larger than that of the latent image of the photoconductor 1 to the first transferring roller 17. In addition, the toner held on the intermediate transfer belt 11 is transferred to the paper P by giving an electric plus charge to the second transferring roller 34.

The paper P holding the toner image on the surface of itself as above is transported to the fixing device 36 and fixed. Then, the paper is transported through the outputting guide 37, and outputted to the outputting stack portion 39 by the outputting roller 38.

When the outputting stack portion 39 is constituted as FIG. 1, the papers are automatically arranged sequentially from the first page, because the papers are stacked on the outputting stack portion 39 with the image plane facing downward. After the image is transferred from the intermediate transfer belt 11 to the paper P, remaining toner and a paper powder are cleaned by the cleaning unit 15 including the cleaning blade 16 inside from the belt surface, and are collected.

In this embodiment, the image is formed on only one side of the paper, but it is possible to constitute an image forming apparatus to form images on both sides of the paper by configuring the second transferring unit 30 as a second intermediate transfer belt. When images are formed in both sides of paper P, a four-color overlaid toner image formed as the first image carried on the surface of the intermediate transfer belt 11 is transferred to the second intermediate transfer belt 30 by the second transferring roller 34.

After that, while another four-color overlaid toner image is being formed as the second image on the intermediate transfer belt 11, the first image is transported to a transfer point by the second intermediate transfer belt 30.

The first image and the second image are transferred to the both sides of paper at the same time by taking timing of the intermediate transfer belt 11, the second intermediate transfer belt and the resisting roller pair 28.

The paper P holding the toner image on the both sides of surface of itself is transported to the fixing device 36 and the both images are fixed at the same time. Then, the paper is transported through the outputting guide 37, and outputted to the outputting stack portion 39 by the outputting roller 38.

In this embodiment, an image forming apparatus forms a color toner image by using a plurality of toner, but it is possible to constitute an image forming apparatus to form a monochrome image by using a black toner.

A way of attachment and detachment of the intermediate-transferring unit 20 from the main body of the image forming apparatus is explained as follows.

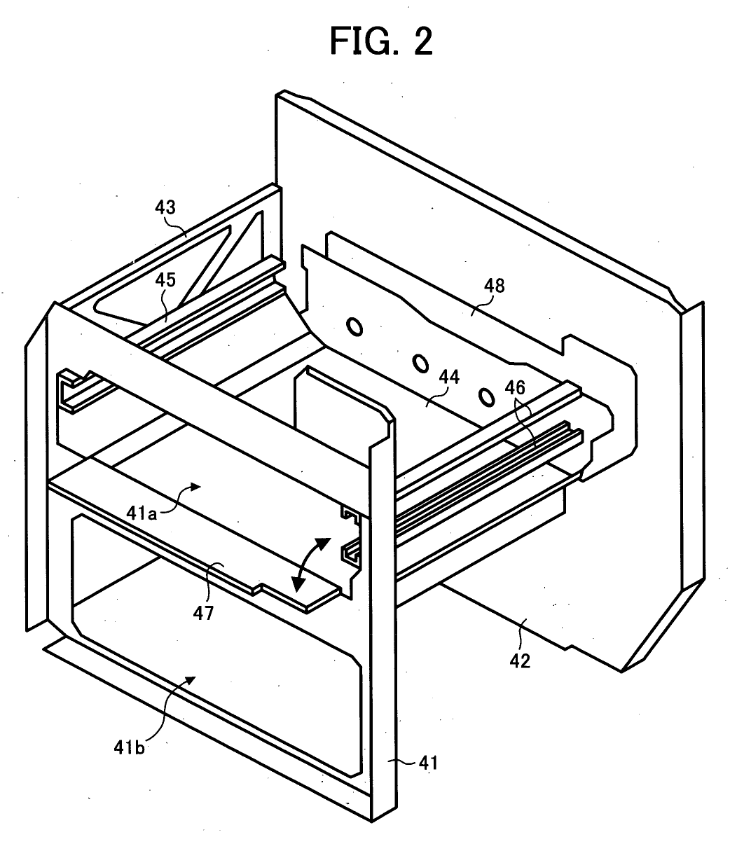

FIG. 2 is a perspective view showing a frame constitution of the main body of the image forming apparatus.

As shown in this figure, the frame of the main body includes a front faceplate 41, a rear faceplate 42, a side plate 43 configured to connect the front faceplate 41 and the rear faceplate 42, and a bottom plate 44.

In addition, a left guide rail 45 and a right guide rail 46 configured to support the intermediate transferring device 10 detachable are fixed between the front faceplate 41 and the rear faceplate 42. An upper opening 41a and a lower opening 41b are placed in the front faceplate 41.

The intermediate transferring unit 20 including the intermediate transferring device 10 and the cleaning unit 15, and each image forming unit SU can be attached to and detached from the main body of the image forming apparatus through the upper opening 41a.

A photoconductor fixing plate 47 configured to open and close the upper opening 41a is fixed to the front faceplate 41 and rotates around an axis. The paper feeding cassette 26-1, 26-2 can be attached to and detached from the main body of the image forming apparatus through the lower opening 41b.

A driving device 48 is attached to the rear faceplate 42. The driving device 48 includes motors and gear alignments configured to drive driving rollers of the photoconductor drum 1, the developing device 5 in the image forming unit SU and the intermediate transfer belt 11.

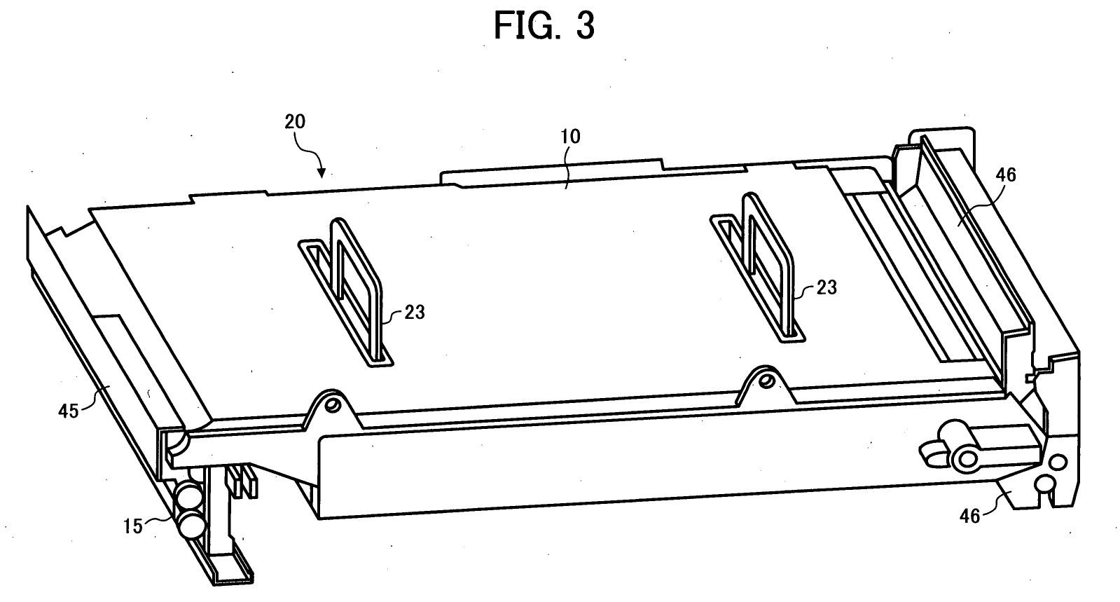

FIG. 3 is a perspective view showing the intermediate transferring unit 20 when the intermediate transferring unit 20 is supported by the guide-rails 45, 46 in right and left.

In this Figure, the frame of the main body is omitted for illustration purposes. The intermediate transferring unit 20 including the intermediate transferring device 10 and the cleaning unit 15 is supported by the guide rails 45, 46 in right and left, and is removable from the main body of the apparatus together. A pair of handles 23 is disposed on the top surface of the intermediate-transferring device 10. These handles 23 are capable of being folded. When the intermediate transferring device 10 or the intermediate transferring unit 20 is drawn from the main body of the image forming apparatus, the handles 23 can be held by hands by drawing them as shown in the FIG. 3. And when the intermediate transferring device 10 or the intermediate transferring unit 20 is inserted in the main body of the image forming apparatus, the handles 23 can be folded along the top surface of the intermediate transferring device 10.

As mentioned before, the intermediate transferring device 10 (the intermediate transferring unit 20) is supported by the guide rails 45, 46 in right and left, and is removable from the main body of the image forming apparatus.

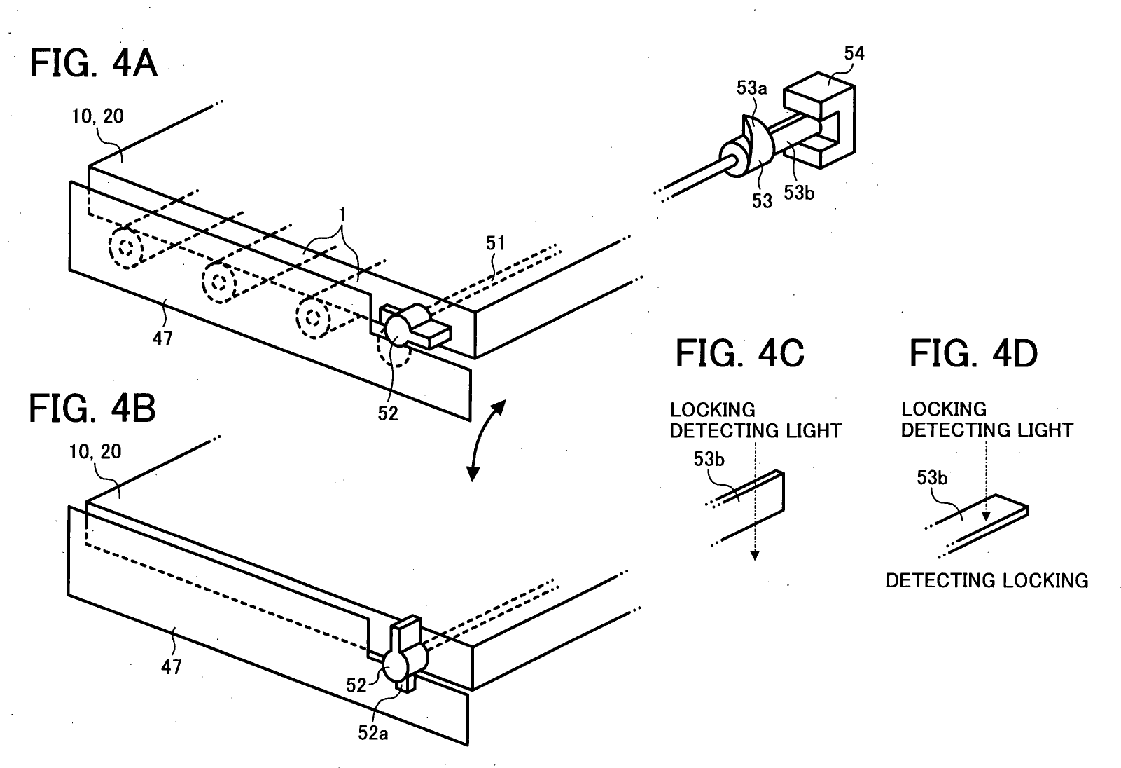

As shown in FIG. 4, a locking device configured to control removal of the intermediate transferring device 10 (the intermediate transferring unit 20) is installed in the intermediate transfer point 10 (the intermediate transferring unit 20). A locking lever 52 is fixed in front end of a shaft 51 that is supported by and through the intermediate transferring device 10 and that rotates with the shaft 51. A locking member 53 is fixed in rear end of the shaft 51. Triangle-shaped protruding portion 53a is formed in the locking member 53. As shown in FIG. 4(a), when an arm of the locking lever 52 is in a horizontal position, locking state is cancellation. Then, the triangle-shaped protruding portion 53a of the locking member 53 is approximately positioned overhead. On the contrary, as shown in FIG. 4(b), when the locking lever 52 is turned 90 degrees counterclockwise, the triangle-shaped protruding portion 53a of the locking member 53 protrudes to left side.

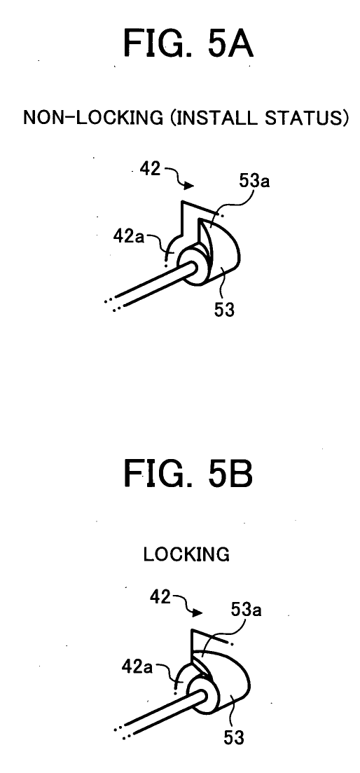

As shown in FIG. 5, an insert portion 42a, which the locking member 53 can get into, is formed in the rear faceplate 42 of the frame of the main body. When the intermediate transferring device 10 (the intermediate transferring unit 20) is installed toward the depths of the main body of the image forming apparatus, the locking member 53 reaches to behind of the rear faceplate 42 through the insert portion 42a. When the locking lever 52 is in a state as shown in FIG. 4(a), the relationship of the locking lever 52 and the fixing plate 42 is shown in FIG. 5(a). As shown in FIG. 5(a), because the locking members 53 is not locked in the rear faceplate 42, the intermediate transferring device 10 (the intermediate transferring unit 20) can be removal from the main body of the image forming apparatus.

When the locking lever 52 is turned as shown in FIG. 4(b) in the state that the intermediate transferring device 10 (the intermediate transferring unit 20) is inserted in to the depths of the main body of the image forming apparatus, the locking member 53 also rotates as shown in FIG. 5(b). Then, the triangle-shaped protruding portion 53a of the locking member 53 gets into the behind of the rear faceplate 42.

In this state, the intermediate transferring device 10 (the intermediate transferring unit 20) can not be withdrawn from the main body of the image forming apparatus, because the triangle-shaped protruding portion 53a of the locking member 53 is locked in the rear faceplate 42.

In addition, when the locking lever 52 is in the locking released state as shown in FIG. 4(a), the photoconductor fixing plate 47 can be opened, because an arm member 52a of the locking lever 52 is not locked in the photoconductor fixing plate 47. When the photoconductor fixing plate 47 is opened, as mentioned before, the intermediate transferring unit 20 supported by the guide rails 45, 46 in right and left is removable from the main body of the image forming apparatus. The intermediate transferring device 10 and the cleaning unit 15 is removable together from the main body of the image forming apparatus. In addition, when a locking device for the cleaning unit (not shown) is removed, the cleaning unit 15 can be detached from the main body of the image forming apparatus independently. Also, each of the image-forming units SU can be removed by opening the photoconductor fixing plate 47.

When the photoconductor fixing plate 47 is closed and the locking lever 52 is in the locked condition (so that the locking lever 52 is disposed in lengthwise direction as shown in FIG. 4(b)), the photoconductor fixing plate 47 is also locked because of the arm member 52a of the locking lever 52 presses the photoconductor fixing plate 47. Thus, the intermediate transferring unit 20 is locked also. Also, removal of the image-forming unit SU is not possible.

A rear protruding portion 53b of the locking member 53 and a sensor 54 are constituted to be able to detect that the intermediate transferring device 10 (the intermediate transferring unit 20) is inserted to the depths of the main body of the image forming apparatus, and it is locked. For example, a photo-interrupter having a light emitting member and a light receiving member can be used as the sensor 54.

In this example, the rear-protruding portion 53b of the locking member 53 is formed in the shape of a plate. In the locking released state as shown in FIG. 4(a), the rear-protruding portion 53b of the locking member 53 entered in a detection area of the sensor 54 can not interrupt the light from the light emitting member as shown in FIG. 4(c). On the contrary, in the locking state as shown in FIG. 4(b) with the locking lever 52 turning, the rear-protruding portion 53b of the locking member 53 interrupts the light from the light-emitting member as shown in FIG. 4(d). By this embodiment, locking of the intermediate-transferring device 10 (the intermediate transferring unit 20) is detected. Thus, this detects the intermediate transferring device 10 (the intermediate transferring unit 20) is set in the main body of the image forming apparatus. When the sensor 54 does not detect a set (a lock) of the intermediate-transferring device 10 (the intermediate transferring unit 20), at least, the image forming apparatus is controlled not to form an image.

In addition to the constitution explained above, a microswitch and other sensing mechanisms could be adopted as the sensor.

In addition, a front cover (not shown) is installed in an outer casing of the image forming apparatus. When the front cover is opened, a front portion of the frame of the device is exposed, and operation of the locking lever 52 and opening of the photoconductor fixing plate 47 are enabled. In addition, exclusive doors can be provided with the outer casing corresponding to the locking lever 52 and the photoconductor fixing plate 47.

In this example, as mentioned before, the intermediate transferring device 10 and the cleaning unit 15 can be attached to and detached from the main body of the image forming apparatus together as the intermediate transferring unit 20. It is possible to constitute the cleaning unit 15 that can be removal from the main body of the image forming apparatus separately while the intermediate transferring device 10 is remaining in the main body of image forming apparatus. When the cleaning unit 15 can be detachable from the main body of the image forming apparatus independently of the intermediate transferring device 10, maintenance work becomes easier because a plurality of devices can be easily attached to and detached from the main body of the image forming apparatus. Often, the life of the cleaning member (for example, cleaning blade 16) is shorter than that of an intermediate transfer belt. Thus, with this embodiment, when the cleaning unit 15 reaches its life, it is not necessary to change the intermediate transferring unit 20 or the intermediate transferring device 10. When the cleaning unit 15 can be removed from the intermediate transferring device 10 after removing the intermediate transferring unit 20 from the main body of the image forming apparatus, the cleaning unit 15 is easily removed from the intermediate transferring device 10 by adopting the rail mechanism. In addition, because the attachment and detachment direction of the intermediate transferring unit 20 is parallel to a rotation shaft of the intermediate transfer belt 11, the constitution detachably supporting the intermediate transferring unit 20 (e.g., the guide rail) is simplified.

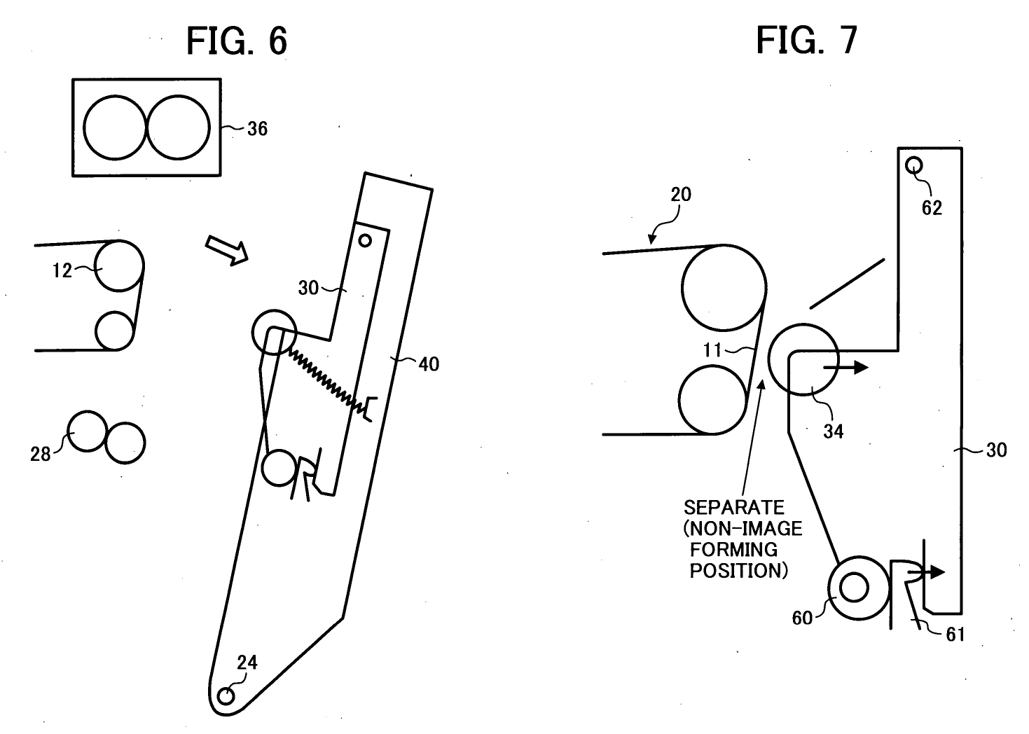

A mechanism of attachment and detachment of the second transferring unit 30 (the transfer roller 34) is explained next. As shown in FIG. 6, the second transferring cover 40 configured to support the second transferring unit 30 is possible to rotate and open around the shaft 24. And when a paper jam occurs, the second transferring cover 40 may be opened to remove the paper from the path of paper transportation.

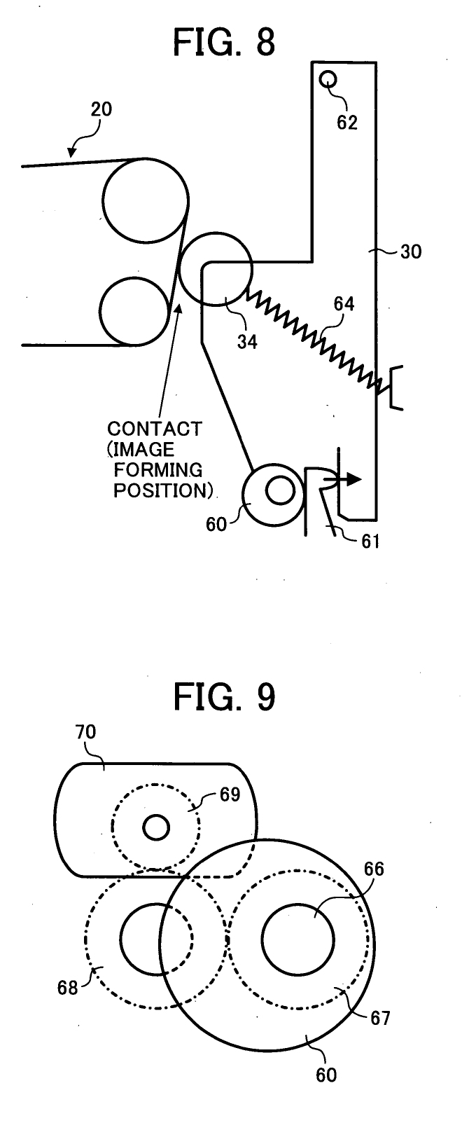

FIG. 7 and FIG. 8 both show a state where the second transferring cover 40 is closed. FIG. 7 shows a closed cover when the image forming apparatus is in a non-image forming state, such as a waiting state. FIG. 8 shows a closed cover when the image forming apparatus is in an image forming state. In the non-image forming state, cam member 60 presses a second transferring unit removing lever 61 in a direction to right in FIG. 7 so as to rotate the second transferring unit 30 around an rotation axis 62. Thus, the second transferring roller 34 is removed from the intermediate transfer belt 11. In the image forming state, the cam member 60 turns a half turn and rotates the second transferring unit 30 around the rotation axis 62 toward the intermediate transferring unit 20. Thus, the second transferring roller 34 is placed in contact with the intermediate transfer belt 11 by the pressing of a pressing member such as a spring attached to the second transferring cover 40.

The mechanism for placing the second transferring unit 30 in and out of contact with the intermediate transferring unit 20 when the second transferring cover 40 is closed with cam member 60 and the second transferring unit removing lever 61 is shown in more detail in FIG. 9. As shown in FIG. 9, rotation of the cam member 60 is performed by engaging of a gear 67 attached to a cam shaft 66 with a gear 68, and engaging of the gear 68 with a worm gear 69 connected to a motor 70. When the motor 70 is not energized in the non-image forming state, as shown in FIG. 7, the second transferring roller 34 removes from the intermediate transfer belt 11 by pressing of the cam member to the second transferring unit removing lever 61. By this mechanism, when the intermediate transferring unit 20 is detached from the main body of the image forming apparatus, the second transferring roller 34 cannot be contacted with the intermediate transfer belt 11. When the motor 70 is energized in the image forming state, as shown in FIG. 8, the second transferring roller 34 contacts with the intermediate transfer belt 11 by turning of the cam member in a half round. By this mechanism, an image on the intermediate transfer belt 11 can be transferred to a paper.

It is also possible to adopt a reverse constitution that the motor 70 is energized in the non-image forming state and then the cam member 60 turns in a half round to remove the second transferring roller 34 from the intermediate transfer belt 11.

The construction of the present invention is not limited to the previously described and illustrated embodiments. For example, a tensioned shape of the intermediate transfer belt or the transportation belt (a transfer belt) may be used, with the constitution of the guide rail set appropriately. In addition, the cleaning device is not limited to a cleaning blade but may also include a cleaning roller or a cleaning brush. Also, alternative types of image forming units or fusing devices may be used.

The preceding apparatus may be a printer, a facsimile, a copier or another type of image forming apparatus.

Numerous modifications and variations of the present invention are possible in light of the above teachings. It is therefore to be understood that within the scope of the appended claims, the invention may be practiced otherwise than as specifically described herein.

1. An image forming apparatus, comprising:
a housing;
an intermediate transferring device within said housing and configured to transfer an image from a photoconductor to be removable from the housing along a rotation axis of the intermediate transferring body;
a transferring device configured to transfer the image from the intermediate transferring body to a transferring material;
a cover part configured to house the transferring part and to open and close in a direction that is perpendicular to the rotation axis of the intermediate transferring body; and
a transferring part moving mechanism within said cover part and configured to move the transferring device between a transferring device/intermediate transferring device contact position and a transferring device/intermediate transferring device non-contact position.

2. The image forming apparatus as claimed in claim 1, wherein the transferring part moving mechanism comprises:
a pressing part configured to press the transferring device to the intermediate transferring device; and
a pressing control mechanism configured to control the pressing part.

3. The image forming apparatus as claimed in claim 2, wherein the transferring part moving mechanism is configured to energize the pressing control mechanism.

4. The image forming apparatus as claimed in claim 3, wherein the pressing part comprises:
a cam member.

5. The image forming apparatus as claimed in claim 1, further comprising:
a plate configured to open and close over an opening of the housing, wherein the intermediate transferring device is configured to be locked to the plate by a first locking mechanism when the plate is closed.

6. The image forming apparatus as claimed in claim 5,wherein the first locking mechanism comprises:
a locking lever having a protruding portion configured to lock the intermediate transferring device to the plate by turning around a locking lever axis.

7. The image forming apparatus as claimed in claim 6, wherein the first locking mechanism comprises:
a locking state detecting portion configured to detect when the intermediate transferring device is locked to the plate.

8. The image forming apparatus as claimed in claim 7, wherein the locking state detecting portion comprises:
a plate shape member.

9. The image forming apparatus as claimed in claim 5, further comprising:
a second locking mechanism configured to lock the intermediate transferring device to the housing.

10. The image forming apparatus as claimed in claim 9, wherein the first locking mechanism and the second locking mechanism are configured to lock the intermediate transferring device simultaneously.

11. The image forming apparatus as claimed in claim 5, further comprising:
a guide rail configured to support the intermediate transferring device as the intermediate transferring device is removed from the housing of the image forming apparatus.

12. The image forming apparatus as claimed in claim 5, wherein the intermediate transferring device comprises:
an upper surface; and
a handle on said upper surface.

13. The image forming apparatus as claimed in claim 5, further comprising:
a cleaning device configured to clean the surface of the intermediate transferring device, wherein the cleaning device is detachable from the intermediate transferring device.

14. An image forming apparatus, comprising:
a housing;
means for intermediate transferring an image from a photoconductor, wherein the intermediate transferring means is removable from inside of the housing along the rotation axis of the intermediate transferring means;
means for transferring the image from the intermediate transferring means to a transferring material;
means for housing the transferring means and for opening and closing in a direction perpendicular to the rotation axis of the intermediate transferring means; and
means for moving the transferring means between a transferring means/intermediate transferring means contact position and a transferring means/intermediate transferring means non-contact position.

15. The image forming apparatus as claimed in claim 14, wherein the means for moving comprises:
means for pressing the transferring means to the intermediate transferring means; and
means for controlling the pressing means.

16. The image forming apparatus as claimed in claim 15, wherein the means for moving enables comprises:
means for energizing the controlling means.

17. The image forming apparatus as claimed in claim 16, wherein the pressing means comprises:
a cam member.

18. The image forming apparatus as claimed in claim 14, further comprising:
means for opening and closing an opening of the housing comprising first means for locking the intermediate transferring means within said housing.

19. The image forming apparatus as claimed in claim 18, wherein the first locking means comprises:
means for detecting a locking state of the intermediate transferring means.

20. The image forming apparatus as claimed in claim 18, further comprising:
second means for locking the intermediate transferring means within the housing.

21. The image forming apparatus as claimed in claim 20, wherein the first locking means and the second locking means are configured to lock the intermediate transferring means simultaneously.

22. The image forming apparatus as claimed in claim 18, further comprising:
means for supporting the intermediate transferring means when the intermediate transferring means is removed from the housing of the image forming apparatus.

23. The image forming apparatus as claimed in claim 18 wherein the intermediate transferring means comprises:
means for lifting the intermediate transferring means.

24. The image forming apparatus as claimed in claim 18 further comprising:
means for cleaning a surface of the intermediate transferring means, said cleaning means detachable from the intermediate transferring means.

25. An image forming apparatus, comprising:
a housing;
a plate configured to open and close an opening of the housing;
an intermediate transferring device configured to transfer and image from a photoconductor, wherein the intermediate transferring device is removable from the housing along a rotation axis of the intermediate transferring device through the opening; and
a transferring device configured to transfer the image from the intermediate transferring device to a transferring material; and
a first locking mechanism configured to lock the intermediate transferring device to the plate when the plate is closed.

26. The image forming apparatus as claimed in claim 25, wherein the first locking mechanism comprises:
a locking lever having a protruding portion configured to lock the intermediate transferring device to the plate by turning around an axis.

27. The image forming apparatus as claimed in claim 26, wherein the first locking mechanism comprises:
a locking state detecting portion configured to detect a locking state of the intermediate transferring device.

28. The image forming apparatus as claimed in claim 27, wherein the locking state detecting portion comprises:
a plate shape member.

29. The image forming apparatus as claimed in claim 25, further comprising:
a second locking mechanism configured to lock the intermediate transferring device to the housing.

30. The image forming apparatus as claimed in claim 29, wherein the first locking mechanism and the second locking mechanism are configured to lock the intermediate transferring device simultaneously.

31. The image forming apparatus as claimed in claim 25, further comprising:
a guide rail configured to support the intermediate transferring device as the intermediate transferring device is removed from the housing of the image forming apparatus.

32. The image forming apparatus as claimed in claim 25, wherein the intermediate transferring device comprises:
a handle located on an upper surface of the intermediate transferring device.

33. The image forming apparatus as claimed in claim 25, further comprising:
a cleaning device configured to clean a surface of the intermediate transferring device, wherein the cleaning device is detachable from the intermediate transferring device.

34. The image forming apparatus as claimed in claim 25, further comprising:
a cover configured to support the transferring device and to open and close in the direction that is perpendicular to the rotation axis of the intermediate transferring device;
a transferring device moving mechanism configured to move the transferring device between a transferring device/intermediate transferring device contact position and a transferring device/intermediate transferring device non-contact position.

35. The image forming apparatus as claimed in claim 34 wherein the transferring device moving mechanism comprises:
a pressing device configured to press the transferring device to the intermediate transferring device;
a pressing control mechanism configured to control the pressing device.

36. The image forming apparatus as claimed in claim 35 wherein the transferring device moving mechanism is configured to energize the pressing control mechanism.

37. An image forming apparatus, comprising:
a housing;
means for opening and closing an opening of the housing means means for intermediately transferring an image from a photoconductor, wherein the intermediate transferring means is removable from the housing along a rotation axis of the intermediate transferring means;
means for transferring the image from the intermediate transferring means to a transferring material; and
first means for locking means the intermediate transferring means when the opening and closing means is closed.

38. The image forming apparatus as claimed in claim 37, wherein the first locking means comprises:
a locking state detecting means configured to detect a locking state of the intermediate transferring means.

39. The image forming apparatus as claimed in claim 37, further comprising:
a second means for locking the intermediate transferring means to the housing means.

40. The image forming apparatus as claimed in claim 39, wherein the first locking means and the second locking means are configured to lock the intermediate transferring means simultaneously.

41. The image forming apparatus as claimed in claim 37, further comprising:
means for supporting the intermediate transferring means when the intermediate transferring means is removed from the housing of the image forming apparatus.

42. The image forming apparatus as claimed in claim 37, wherein the intermediate transferring means comprises:
means for carrying the intermediate transferring means.

43. The image forming apparatus as claimed in claim 37, further comprising:
means for cleaning a surface of the intermediate transferring means, wherein the cleaning means is detachable from the intermediate transferring means.

44. The image forming apparatus as claimed in claim 37, further comprising;
means for housing the transferring means and for opening and closing in a direction perpendicular to the rotation axis of the intermediate transferring means; and
means for moving the transferring means between a transferring means/intermediate transferring means contact position and a transferring means/intermediate transferring means non-contact position.

45. The image forming apparatus as claimed in claim 44, wherein the moving means comprises:
means for pressing the transferring means to the intermediate transferring means;
means for controlling the pressing means.

46. A method of servicing an image forming apparatus, comprising:
unlocking a plate on a housing and covering an intermediate transferring device by a first locking mechanism;
opening said plate; and
removing the transferring device along a rotation axis of the intermediate transferring device through an opening of the housing.

47. The method of claim 46, further comprising:
inserting the intermediate transferring device or a replacement intermediate transferring device along the rotation axis of the transferring device through a opening of the housing;
closing said plate;
locking the intermediate transferring device with a first locking mechanism.

48. The method of claim 47, wherein said step of locking the intermediate transferring device with a first locking mechanism comprises:
turning a locking lever around an axis, said locking lever having a protruding portion configured to lock the intermediate transferring device to the plate.

49. The method of claim 48, further comprising:
detecting a locking state of the intermediate transferring device.

50. The method of claim 47, further comprising:
locking the intermediate transferring device with a second locking mechanism to the housing.

51. The method of claim 50, wherein said steps of locking with the first locking mechanism and the second locking occur simultaneously.

52. The method of claim 47, further comprising:
supporting the intermediate transferring device with a guide rail when the intermediate transferring device is inserted into or removed from the housing of the image forming apparatus.
